(19) United States
(12) Patent Application Publication
(10) Pub. No.: US 2025/0224068 A1
(43) Pub. Date: Jul. 10, 2025

(54) AUTONOMOUS IN-FLUID ROBOTIC SYSTEM

(71) Applicant: Motmot, Inc., Detroit, MI (US)

(72) Inventors: Elliot Rand Smith, Novi, MI (US); Demetris Coleman, Annapolis Junction, MD (US)

(73) Assignee: Motmot, Inc., Detroit, MI (US)

(21) Appl. No.: 19/015,400

(22) Filed: Jan. 9, 2025

Related U.S. Application Data
(60) Provisional application No. 63/619,087, filed on Jan. 9, 2024.

(51) Int. Cl. F16L 55/46; F16L 55/32; F16L 55/40

(52) U.S. Cl. CPC F16L 55/46; F16L 55/32; F16L 55/40

(57) ABSTRACT

An autonomous underwater robotic (AUR) vehicle for use in pipe inspection including (a) a main body configured for housing a controller coupled to one or more sensors; (b) a propulsion system having one or more thrusters configured for propelling the AUR vehicle through a target system; (c) a rechargeable power source provided in the main body and coupled to the controller; (d) a data storage module coupled to the one or more sensors configured for storing and transmitting any acquired data from the one or more sensors; (e) at least one camera configured for capturing images; and (f) a navigation system configured to direct the AUR vehicle and finding a docking station for data transfer and power recharge.

### CROSS-REFERENCE TO RELATED APPLICATIONS

This application claims the benefit of U.S. Provisional Patent Application No. 63/619,087 filed Jan. 9, 2024, titled “AUTONOMOUS IN-FLUID ROBOTIC SYSTEM,” hereby incorporated by reference in their entirety.

### FIELD

The present disclosure relates robotics and robotics deployment systems, specifically to autonomous robotic units and systems configured for in-fluid operations.

### BACKGROUND

The drinking water infrastructure space, designed in the mid-20th century, is approaching the end of its functional lifespan. With systems aging, major cities and municipalities are witnessing a significant uptick in system leaks, breaks, and related failures. Most municipalities and water authorities are grappling with a significant lack of visibility into and data in their capital infrastructure assets. The elevating water crises in major cities have further amplified the issue, garnering substantial public awareness about the vital need for water security.

For many infrastructure owners, the cost of assessing the state of their pipeline infrastructure remains prohibitively high causing them to focus solely on the most critical areas. The current state of in-fluid pipeline inspection and maintenance presents challenges in the deployment and retrieval of inspection robots, as well as in the efficient management of the power and data they collect. There is a need for a system that can integrate with existing pipeline infrastructure to provide enhanced utility and functionality for Autonomous Robotic Units (AURs) engaged in such inspections. A need remains for an improved device and system to assist and improve data acquisition and real-time infrastructure assessment.

### BRIEF SUMMARY

In one aspect, an autonomous underwater robotic (AUR) vehicle for use in fluid pipe inspection, the AUR vehicle includes: (a) a main body for housing a controller coupled to one or more sensors, (b) a propulsion system having one or more thrusters for propelling the main body through a target pipe system, (c) a rechargeable power source coupled to a body core of the main body, (d) a data storage module coupled to the sensors for storing and transmitting any acquired data from the sensors, (e) at least one camera for capturing images within the fluid pipe system, and (f) a navigation system coupled to the controller configured to direct the movement of the AUR vehicle and find a corresponding docking station for data transfer and power recharge.

In another aspect, a Home Docking Station (HDS) configured to attach directly to a fluid pipeline system and provide a launch and retrieval point for one or more AURs, includes: (a) an entry point mechanism configured to maintain environmental seals and protective measures to ensure the integrity of the HDS and the AURs in varying fluid conditions, (b) an exterior housing including a reservoir for draining fluid and robust to withstand environmental factors, (c) a communication and sensory array having an array of sensors to detect proximity of an AUR and a communication module for remote communication with operators and the like, and (d) an internal magnetic capture mechanism configured to align and secure the AUR upon re-entry onto an HDS-pipe junction, and further including an inductive charging platform configured for providing power required to recharge AUR batteries, where the magnetic capture mechanism is equipped with data transfer capabilities configured for data upload and transferring gathered inspection data for processing and subsequent relay to a GIS and/or cloud network when an AUR is docked.

In yet another aspect, a fluid pipe inspection and assessment method includes: (a) providing an AUR vehicle as set forth herein and a docking station for recharging the AUR vehicle and communication with the AUR vehicle, (b) entering the AUR vehicle within a target fluid pipe system through an entry point to minimize disruption of normal fluid behavior, (c) planting the docking station and confirming an established communication module with the AUR vehicle, (d) initiating a data gathering protocol to obtain sensor data, and (e) returning to the docking station periodically for recharging and data transfer.

In even another aspect, an Auxiliary In-System Docking Station (AISDS) for AURs, configured to attach internally to a fluid pipeline system, providing recharging and data upload functionalities to the AUR, includes: (a) a magnetic capture mechanism configured to secure to an AUR for recharging and data transfer without necessitating system deployment or retrieval functions, (b) a communication module configured for data upload from the AUR to an external network and for receiving instructions from operators, (c) an energy storage unit that provides a continuous power supply to AURs for extended inspections, (d) a streamlined design that minimizes obstruction within the fluid pipeline and allows for the uninterrupted flow of fluid, and (e) self-diagnostic capabilities to ensure functional integrity and to notify operators of any maintenance requirements, where the communication module is optionally capable of handling multiple data transfer sessions simultaneously for a fleet of AURs and optionally equipped with a modular design that allows for easy replacement of components and upgrades as technology advances, and where the communication module is configured for providing firmware or software updates to docked AURs to enhance functionality or adapt to inspection parameters.

In still another aspect, a locator ring or locator ring system designed to be installed within a fluid pipeline system to detect and track the passage of AURs includes: (a) a plurality of sensors, (b) a communication module to relay the position of AURs to corresponding docking stations and/or a home base in real-time or near real-time, (c) a navigation module configured to assist in AUR navigation and operational decision-making processes, (d) a diagnostic system configured to determine the status of AURs that may be stationary or in need of assistance within the fluid pipeline system, (e) a modular design allowing for easy installation and maintenance without significant alterations to the fluid pipeline system, (f) an energy harvesting system configured to generate power from the fluid flow within the pipeline to sustain its operations, and (g) a backup power source to ensure uninterrupted functionality in the event of primary power failure, where the locator ring employs an encryption protocol for secure communication of AUR locations and diagnostics and is adaptable to various pipe diameters and profiles to provide comprehensive coverage within diverse pipeline systems.

In one aspect, a Home Docking Station (HDS) configured to attach directly to a fluid pipeline system and provide a launch and retrieval point for an autonomous underwater robotic (AUR) vehicle, includes (a) a chlorination pressure chamber configured decontaminating an AUR vehicle and adjusting the pressure within the chamber configured to allow access to retrieve or deploy the AUR vehicle, (b) a secondary chamber having an internal magnetic capture mechanism configured for transmitting data, power charging, and holding the AUR before entering the chlorination pressure chamber, (c) a communication and sensory array configured to detect proximity of the AUR vehicle and a communication module for remote communication with operators, and (d) where the magnetic capture mechanism is equipped with a data transfer module configured for data upload and transferring gathered inspection data for processing and subsequent relay to a GIS and/or cloud network when an AUR vehicle is docked. The HDS may also include where the secondary chamber includes a magnetic inductive charging platform configured for providing power required to recharge the AUR vehicle. The HDS may also include further includes a magnetic retrieval system for capturing the AUR as it returns from inspections within the fluid pipeline system. The HDS may also include where the internal magnetic capture mechanism is equipped with recharging facilities configured to replenish the power of the AUR vehicle post-inspection and prior to subsequent deployment. The HDS may also include where the external housing is compatible with various fluid pipeline systems, including water mains, oil pipelines, and other fluid transport systems. Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example schematic top view of a quad-thrust robotic unit (AUR) of the present disclosure.

FIG. 2 illustrates a front side view of the quad-thruster AUR of FIG. 1.

FIG. 3 illustrates a side profile view of the quad-thruster AUR of FIG. 1.

FIG. 4 illustrates an example schematic top view of an octo-thrust AUR of the present disclosure.

FIG. 5 illustrates a front view of the octo-thrust AUR of FIG. 4.

FIG. 6 illustrates a side profile view of the octo-thrust AUR of FIG. 4.

FIG. 7 illustrates a schematic flow chart of a control system according to the present disclosure.

FIG. 8 illustrates an example schematic of a quad-thruster AUR with a pipe system at or near a charging station.

FIG. 9 illustrates an example schematic top view of a single rear-thruster AUR of the present disclosure.

FIG. 10 illustrates an example schematic top view of a dual rear-thruster AUR of the present disclosure.

FIG. 11 illustrates a schematic of a manhole access to a pipe system with gate valve and Home Docking Station (HDS) fixed to a water main pipe with communication line to plate at grade.

FIG. 12 illustrates a schematic of a HDS attached to a water main pipe, illustrating attachment, internal piping capture, bleeding, and containment space from a system.

FIG. 13A is a schematic perspective view of an alternative configuration of a quad-thruster AUR designed for efficient movement through a water system.

FIG. 13B illustrates a front view of the quad-thruster AUR of FIG. 13A.

FIG. 14 illustrates a schematic side view of a home docking station (HDS) system of the present disclosure having a chlorination pressure chamber and a secondary chamber.

FIG. 15A illustrates a top side view of the HDS system of FIG. 14 connected to a pipe system.

FIG. 15B illustrates a perspective view of the HDS system of FIG. 14 connected to a pipe system.

### DETAILED DESCRIPTION

The present disclosure provides for an autonomous underwater robotic vehicle (“AUR”) for use in a system and method for inspection of underground and/or underwater assets and infrastructure systems like pipelines and the like. In an example, the vehicle and system are configured for drinking water infrastructure assessment, however, it is adaptable to other environments such as oil pipelines and various fluid transport systems.

The present disclosure provides for a Home Docking Station (HDS) that attaches directly to fluid pipelines. This HDS serves as the primary deployment, retrieval, and maintenance hub for one or more AURs. It is designed to interface with the pipeline, deploy AURs into the fluid system, capture them upon completion of their inspection tasks, recharge their batteries, and upload the data gathered to a GIS network. In an example, the capture can be magnetic. The system is also configured to allow single or limited deployment to allow for scheduled evaluation and monitoring or troubleshooting.

The AUR is configured for infrastructure assessment through deployment of the AUR directly into pipelines of a target infrastructure. Some benefits of the present disclosure include, but are not limited to, improvement or elimination of limited visibility and expensive inspection methods, improvement, or elimination of traditionally used by pipe infrastructure owners, which often lead to reactive solutions, improvement or elimination of costly emergency recoveries, and reduction or elimination of system interruptions.

Various AUR designs are within the scope of the present disclosure. These various configurations can utilize diverse propulsion systems for varied navigational needs, including the ability to reverse, hover, and bypass obstructions. Its variable sensor suite may include high-resolution cameras, ultrasonic sensors, and probes to detect anomalies and ensure water quality. In an example, these variable sensors may be interchangeable.

In another example, the AUR includes a buoyancy control system with ballast buoyancy control configured to enable positioning. The AUR may further include a power supply and communication system to facilitate extended operations and data relay. The AUR may be configured to integrate with a docking station configured for data offload and recharging.

The system may be operable for near real-time asset visibility, thus reducing reactive measures and optimizing infrastructure maintenance. The AUR can be tailored for in-fluid pipeline inspections, with an emphasis on aging drinking water infrastructure. This provides a thorough assessment method, alleviating the issues from conventional and limited visibility inspection methods.

Solutions achievable by an AUR of the present disclosure include but are not limited to: (i) conducting extended, uninterrupted in-system inspections; (ii) navigating with enhanced mobility, including the ability to reverse and bypass obstructions; and (iii) integrating with proprietary in-system docking stations. An aspect of the present disclosure includes the ability to provide infrastructure owners and communities with cost-effective visibility into their assets and gather near real-time data. This allows for predictive maintenance and diagnostics without costly and challenging exploration.

An AUR of the present disclosure includes a main body, a propulsion system, a controller, a rechargeable power source (i.e., a battery), and one or more sensors. The propulsion system includes one or more thrustors to propel the main body along with the corresponding components in a desired direction. The controller is coupled to the power source and the one or more sensors for collecting data in a data storage module. The AUR is configured to locate within a target asset system, an HDS for both recharging the power source and transferring any collected data. In another example, the AUR can be controlled remotely to obtain data from a target region or area. The AUR main body should be constructed to survive within an underwater or submerged environment.

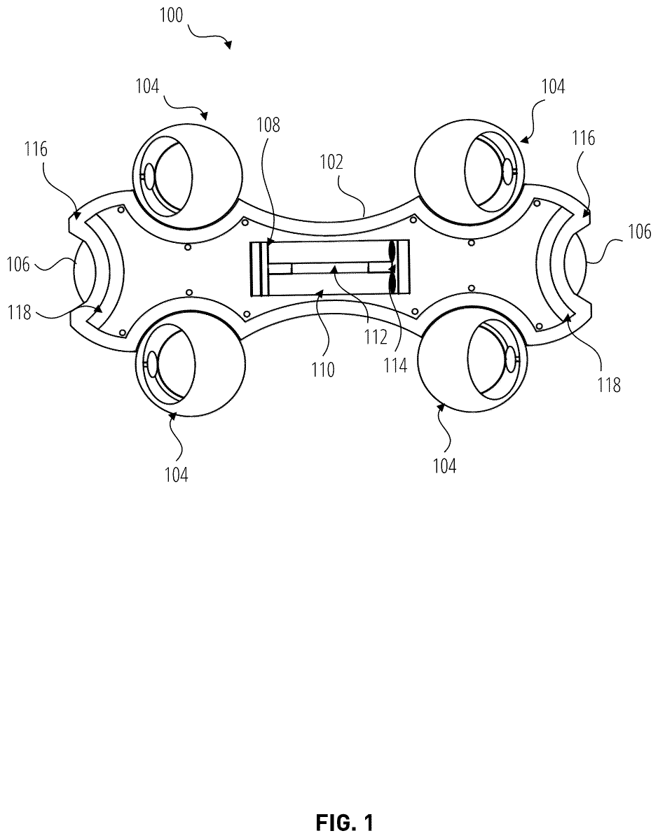

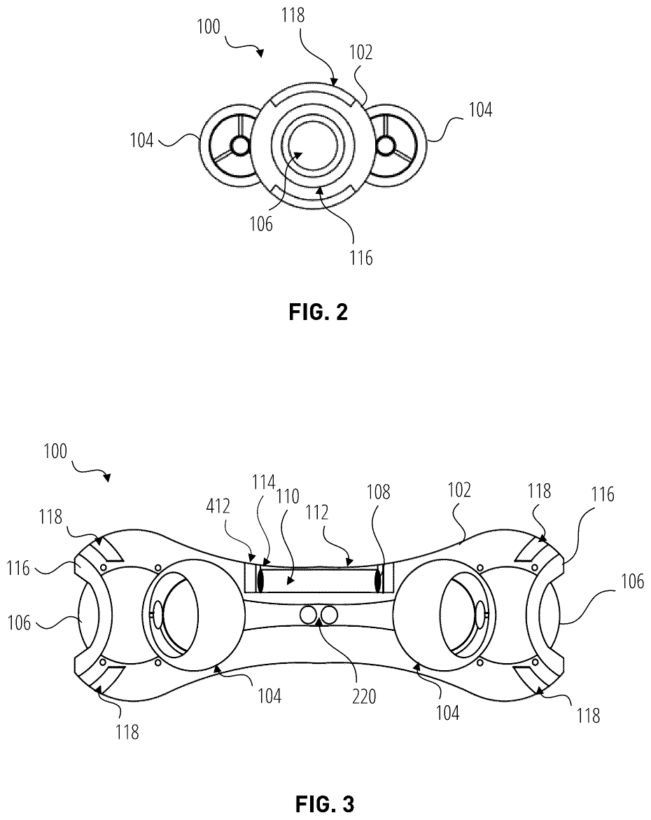

Referring to FIGS. 1-3 and 8, a quad-thruster AUR 100 is shown. In this example, four thrusters 104 are positioned symmetrically around quad-thruster main body 102. The thrusters 104 are configured for maneuverability and to hover or remain stationary against fluid flow. In this example, the quad-thruster AUR 100 includes one or more optic sensors 106. Optic sensor 106 may include a high resolution camera for capturing image information. Impact bumpers 116 are positioned around quad-thruster main body 102. The impact bumpers 116 are provided to protect quad-thruster AUR 100's physical integrity and internal components. A pressure-resistant hull can be included and crafted from lightweight, yet durable materials, ensuring structural integrity under potential high pressures. The quad-thruster main body 102 may further include internal flexible bladders that can be filled or emptied to tune buoyancy, ensuring positive positioning during inspections.

The quad-thruster main body 102 includes a body core 112 for housing the power source, navigation, and communication control through a controller. The body core 112 may include a ballast system 108 for buoyancy control actuation, power transfer magnet capture 110 for power transfer when recharging. In this example, a hull gap 114 is provided for additional buoyancy control, and positioning of a pressure sensor, a temperature sensor, and/or a conductivity probe. Positioned next to the optic sensor 106 and impact bumper 116 is a light 118 which may include red, green, blue (“RGB”) light structured sensors. In this example, a data transfer capture 412 is included in the body core 112. In an example, the data transfer capture 412 is magnetic data transfer. The quad-thruster AUR 100 may also include a sonar sensor 220 shown as a pair of sensors for transmitting and receiving.

In another embodiment, a vectored thrust variant is provided. In this example, the AUR is equipped with pivoting thrusters 104 that can change angles relative to the quad-thruster main body 102. This design variant offers additional precision and directional control and the ability to make sharp turns or rapid altitude adjustments.

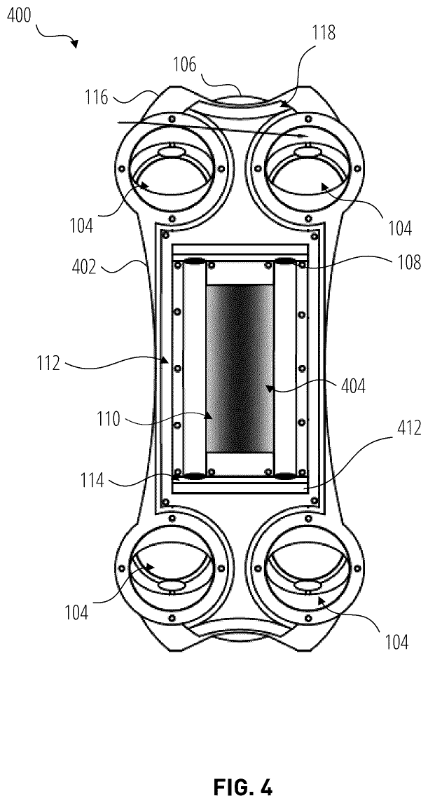

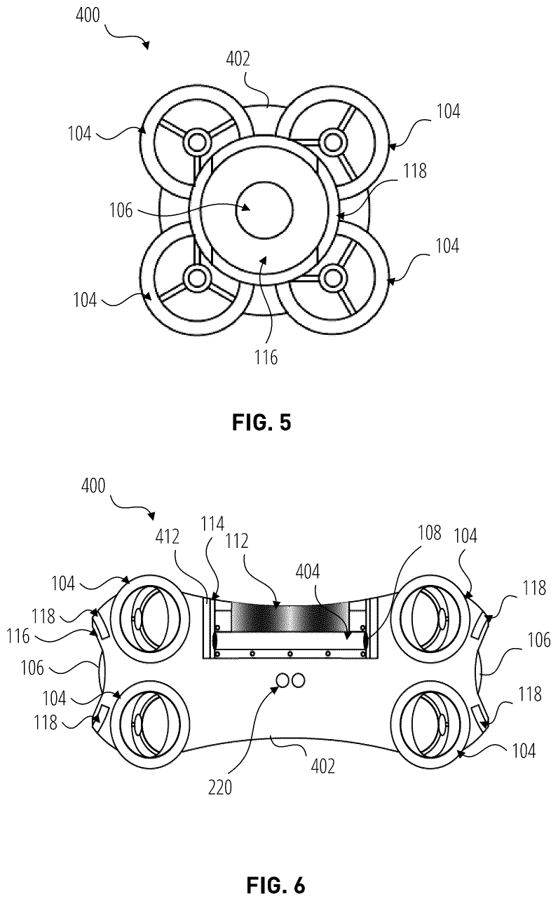

Referring to FIGS. 4-7, an octo-thrust AUR 400 is shown having an octo-thrust main body 402. In this example, eight thrusters 104 are positioned around octo-thrust main body 402. These thrusters 104 are configured for maneuverability and to hover or remain stationary against fluid flow. In this example, the octo-thrust main body 402 includes one or more optic sensors 106 that may include a high-resolution camera for capturing image information within a target asset system. The octo-thrust main body 402 further includes impact bumpers 116 to help protect the physical integrity of the octo-thrust AUR 400 and any internal components.

In this example, octo-thrust AUR 400 includes a body core 112 provided for housing the power source, navigation, and communication control through a controller. The body core 112 may include a ballast system 108 for buoyancy control actuation, power transfer magnet capture 110 for power transfer when recharging at an HDS 802. A hull gap 114 is provided for additional buoyancy control. The hull gap 114 may also allow for positioning of a plurality of sensors including, but not limited to a pressure sensor, a temperature sensor, and/or a conductivity probe.

Positioned next to the optic sensor 106 and impact bumper 116 is a light 118. Light 118 may include RGB light structured sensors. A data transfer capture 412 is provided in the body core 112. The octo-thrust AUR 400 may also include a sonar sensor 220 shown as a pair of sensors for transmitting and receiving. The sonar sensor 220 is positioned on both lateral sides of the octo-thrust AUR 400.

In a further example, an integrated vertical thruster variant includes vertical movement with specialized upward and downward facing thrusters. This variant is suitable for pipes with significant vertical segments or when inspections require meticulous vertical scans. The octo-thrust AUR 400 of FIGS. 4-6 may be a suitable solution for this type of system.

In yet another example, a hybrid propulsion variant is provided. This variant includes a robotic unit with primary rear thrusters 104, supplemental vectored thrusters, and vertical control units. This example may be suitable for balance of speed, maneuverability, and vertical movement capabilities.

The present disclosure relates to a system for comprehensive and efficient inspection of in-fluid pipelines. This includes inspection and assessment of drinking water infrastructure. The AUR, based on its specific variant, can be deployed into a pipeline system via an access point or manhole. Its size and shape should be configured to accommodate for minimal disruption during entry.

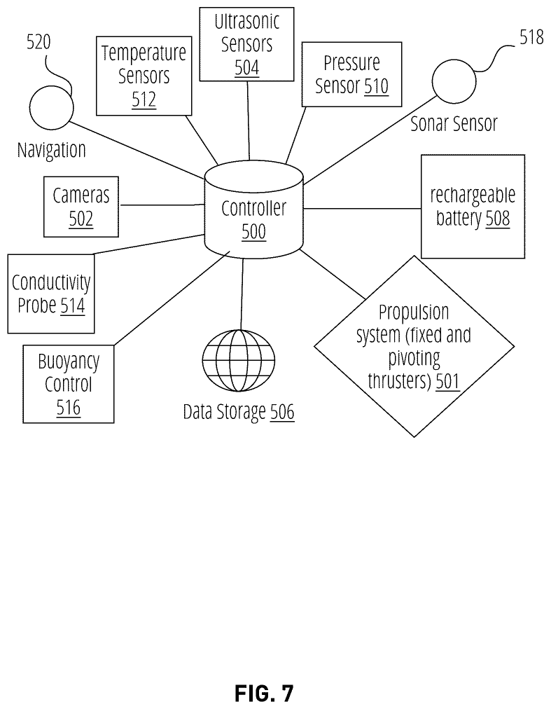

Referring to FIG. 7, a schematic configuration map is provided to illustrate the various options available for an AUR system of the present disclosure. In this example, a central controller 500 is provided. The controller is coupled to the propulsion system 501 for actuating and maneuvering of any thrusters 104. Propulsion system 501 may include fixed and pivoting thrusters, with varying degrees of freedom and symmetry allow for unit control to enable velocity and stability.

Controller 500 is coupled to one or more sensors or data gathering instruments. These may include, but are not limited to one or more cameras 502, like a high-resolution camera. The cameras 502 can be positioned at strategic locations on an AUR body. The cameras 502 can be configured to provide live visual data of a pipeline's interior. Ultrasonic sensors 504 may also be included and used to detect wall thickness, anomalies, and potential breaches in the pipeline. A pressure sensor 510 can be coupled to the controller for measuring internal fluid pressure and identifying any abnormal spikes or drops which could signify an issue. Temperature sensors 512 are configured to detect unusual temperature changes which could affect the quality and safety of the water. A conductivity probe 514 can be provided to monitor fluid system purity and signal if any foreign contaminants are present.

Controller 500 is coupled to a buoyancy control system 516 that includes a ballast tank to allow the AUR to adjust real time buoyancy, aiding in navigation, especially in variable oriented pipeline segments. A power supply (e.g., rechargeable battery 508) may include a battery pack of high-capacity, rechargeable battery units (i.e., lithium powered, or other) that provide extended operational time. In this example, charging is achieved through power transfer magnet capture 110. The AUR's of the present disclosure may further include a wireless communication module that enables docking data transmission and allows HDS 802 to remotely control, when the AUR is in vicinity, when necessary. The controller 500 should include data storage 506 which can be a high-capacity data storage with backup redundancy measures. Navigation 520 can be configured to direct an advanced propulsion system 501 and incorporate machine learning as the AUR navigates through the pipeline.

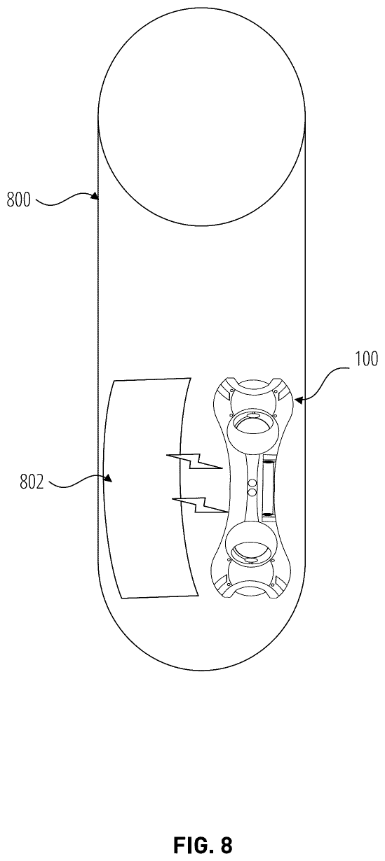

FIG. 8 illustrates a schematic of a target pipe asset pipe system 800 with a quad- thruster AUR 100 provided therein. When ready, quad-thruster AUR 100 is configured to find the docketing HDS 802 for recharging the rechargeable battery 508 and offloading or communicating any data obtained by the sensors.

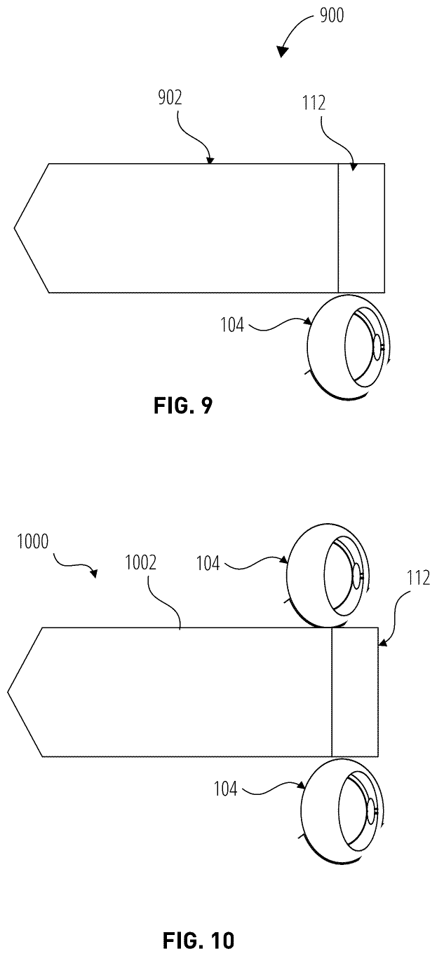

Referring to FIG. 9, in one embodiment, a single rear-thrust AUR 900 includes a single-thrust AUR 902, a body core 112, and a single rear propulsion thruster 104. This configuration can be suitable for straight-line inspections and simple navigational tasks.

Referring to FIG. 10, in another example, the present disclosure provides for a dual-thruster AUR 1000. The dual-thrustor AUR 1000 includes a dual-thrust main body 1002, a body core 112, and twin rear propulsion thrusters 104 for increased speed and stability, especially beneficial in larger diameter pipes or faster flowing fluid conditions.

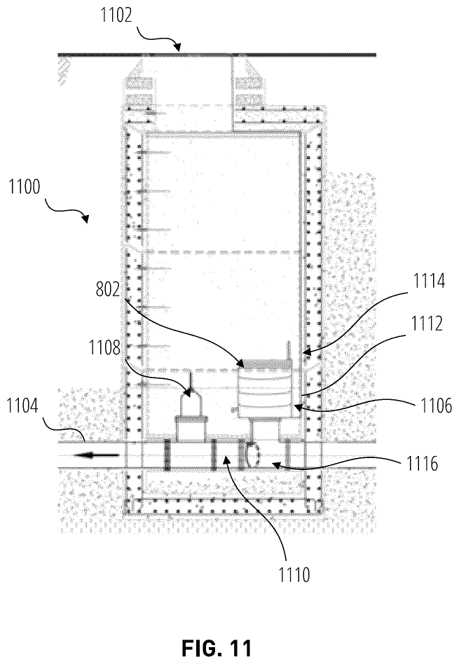

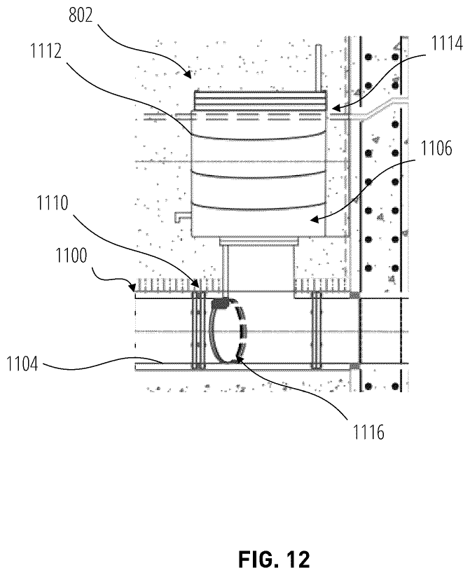

Referring to FIG. 11 and FIG. 12, an example HDS 802 is shown schematically within a fluid pipe system 1100. The HDS is configured to facilitate deployment, retrieval, recharging, and data management of AURs within fluid pipe system 1100. The HDS 802 is characterized by its multi-functional design that provides an effective interface between the AURs and the fluid pipe systems 1100 for which they are intended.

HDS 802 includes a secure entry point 1110 into the fluid pipe system 1100, which is equipped with a mechanical sealing mechanism. This seal ensures that there is no leakage of fluid when AURs are deployed or retrieved, maintaining the integrity of the fluid pipe system 1100. An exterior housing 1112 of the HDS 802 can box-shaped and should be robust and designed to withstand environmental factors. It includes a reservoir 1106 for draining fluid, which can be utilized during maintenance of the HDS 802 or in the event of an overflow, to maintain water quality and manage excess fluid effectively.

The HDS 802 is equipped with a communication and sensory array 1114 having a plurality of sensors for detecting the proximity of an AUR. These sensors enable the HDS 802 to prepare for the docking process as an AUR approaches. The HDS 802 includes a communication module that allows operators to remotely instruct the HDS 802 to deploy AURs into the system, including any secondary AURs if required.

Internally, the HDS 802 features a magnetic capture mechanism that aligns and secures the AUR upon re-entry onto the HDS-pipe junction. This magnetic capture system also functions as an inductive charging platform, providing the power required to recharge the AUR's power source, such as rechargeable batteries 508. The HDS 802 also includes a data transfer interface. The magnetic capture mechanism is equipped with data transfer capabilities. Upon docking, the AUR engages in a data upload with the HDS 802, transferring gathered inspection data for processing and subsequent relay to a GIS and/or cloud network.

The HDS 802 can be designed to be installed within existing access points in the fluid pipe system 1100, such as gate valves 1108 or manholes 1102. This allows for easy access by maintenance personnel and integration into the pipeline infrastructure. Water quality management can be integral to the design focused on maintaining the water quality within the fluid pipe system 1100. The reservoir 1106 and associated mechanisms ensure that the introduction and operation of the HDS 802 does not compromise the quality of the fluid within the fluid pipe system 1100.

The present disclosure provides for secondary deployment capabilities. In the case of extensive pipeline systems or specific inspection requirements, the HDS 802 can communicate the need for additional AUR deployment, ensuring comprehensive coverage and inspection continuity. Regarding operational protocol, the HDS 802 operates under a set of protocols that govern the deployment frequency, retrieval operations, charging cycles, and data management processes. These protocols ensure the efficient and reliable functioning of the AURs and the overall inspection system.

The present disclosure relates to support systems for in-pipe robotic operations, particularly to a docking station designed for in-system servicing of AURs without deployment or retrieval capabilities. The maintenance and inspection of fluid pipe systems are enhanced using AURs. However, the complexity and cost of a dedicated HDS that deploy and retrieve AURs can be challenging for some to adopt. In an example, a solution is provided that includes in-system support to AURs, extending their operational range and effectiveness without an HDS. The present disclosure provides for an Auxiliary In-System Docking Station (AISDS) that provides in-system recharging and data upload capabilities for AURs. The AISDS is designed to be installed within fluid pipe systems more frequently and at a lower cost, addressing the need for regular maintenance without the mechanical complexities of deployment and retrieval.

In an example, the present disclosure provides for an AISDS including:
(i) a magnetic capture mechanism/system to secure AURs as they navigate close to the station. This allows for alignment and coupling between the AUR and the AISDS, ensuring a reliable connection for power transfer and data exchange;
(ii) a recharging system for delivering a rapid and efficient transfer of energy to recharge the AUR's batteries, once docked, and can be configured for reduction or minimal downtime and extended operational periods for the AUR within the pipeline system;
(iii) a data transfer interface including a high-speed data transfer interface that facilitates the upload of gathered inspection data from the AUR to a centralized GIS and/or cloud network, wherein this interface can be designed to manage robust data packages and ensure integrity during transfer;
(iv) a communication module configured for managing data upload processes and receiving operational commands from external operators, wherein the module can signal the need to deploy secondary AURs from an HDS or adjust inspection protocols based on real-time analytics.
(v) an energy storage unit that maintains a continuous power supply, ensuring that AURs can be recharged as needed, even in the event of interruptions to the primary power source; and
(vi) construction materials chosen for durability and compatibility with the internal environment of fluid pipelines including materials resistance to corrosion, fluid pressures, and varying temperatures.

Some design considerations for the AISDS features can include ensuring it does not impede the flow of fluid within the pipeline. Its profile can be configured such that it can be installed without significant modifications to the pipeline structure, maintaining the integrity and throughput of the system. The AISDS can further include self-diagnostic capabilities such as performing self-diagnostic checks to monitor its functional status. Should any component fall below optimal performance levels, the station can autonomously notify operators for maintenance or intervention. The AISDS can further be designed with modularity in mind, allowing for the easy replacement of its components.

The AISDS can further include a collapsible structure for ease of installation in older or irregularly shaped pipeline systems. The recharging system can be configured to include an energy harvesting mechanism that utilizes fluid flow within the pipeline to generate power for its operations. In another example, an integrated fluid sampling mechanism is provided for collecting and analyzing fluid quality within the pipeline. A self-diagnostic system can be provided that is configured to automatically notify operators of required maintenance or repairs through a secure communication network. In an example, a multi-AUR management module is provided that is configured to simultaneously recharge and communicate with multiple AURs.

The present disclosure further provides for in-pipe AUR locator rings 1116 installed within a fluid pipe system 1100 for detecting and tracking in-pipe AUR operations. In the field of pipeline inspection and maintenance, the ability to track the location of AURs can be valuable for efficient operation and management. Many systems lack a dedicated mechanism for precise, real-time tracking of AURs within pipeline systems, which can lead to difficulties in managing inspection routines and rescuing AURs that may become incapacitated or lost. Using locator rings 1116 that are affixed to the interior of pipes 1104 at intermittent distances can alleviate these issues. The locator rings 1116 can be equipped with sensors capable of detecting the passage of AURs, facilitating live tracking, and communication between the AURs, docking stations, and home base. In the event of an AUR failure, these locator rings 1116 serve a role in pinpointing the location of the AUR, enabling swift diagnostic and retrieval actions.

In an example, a locator ring 1116 includes:
(i) a series of sensors that detect the presence and movement of AURs within the fluid pipe system 1100; and these sensors can be configured to identify specific AURs based on their unique signatures;
(ii) a communication system configured to send real-time data regarding the AUR's position relative to the docking stations and home base, and the system can be configured to use encrypted signals to maintain security and integrity of data;
(iii) navigation assistance to the AURs by providing them with positional feedback, allowing for adjustments in their inspection routes as necessary;
(iv) diagnostic functionality in the event of an AUR becoming stationary due to a malfunction or obstruction, wherein the locator rings 1116 can perform diagnostics to assess the situation and help determine the AUR's exact location for retrieval purposes;
(v) construction materials chosen for durability and compatibility with the internal pipeline environment, ensuring and/or assisting with long-term functionality without degradation;
(vi) an optional energy harvesting mechanism that leverages kinetic energy of fluid flow to power their operations; and
(vii) optional modularity to allow for easy installation at various points along the pipeline without the need for extensive modifications, suitable for a range of pipe diameters and profiles.

Installation and access can be achieved by selecting a locator ring design to be installed within existing access points in the fluid pipeline system, such as gate valves or manholes. This allows for easy access by maintenance personnel and integration into the pipeline infrastructure.

The locator ring configuration can further include a mechanism to identify specific AURs by unique electronic signatures and relay this data to a centralized management system. An energy harvesting system is configured to convert kinetic energy from fluid flow into electrical power for extended operations. A modular attachment system can be provided that allows for rapid deployment and removal without disrupting pipeline operations. A communication module is configured to transmit encrypted real-time data regarding AUR positions and diagnostics to both docking stations and remote operators. A navigation assistance system can further be included to provide directional guidance and real-time positional feedback to AURs within the communication tributary of the pipeline.

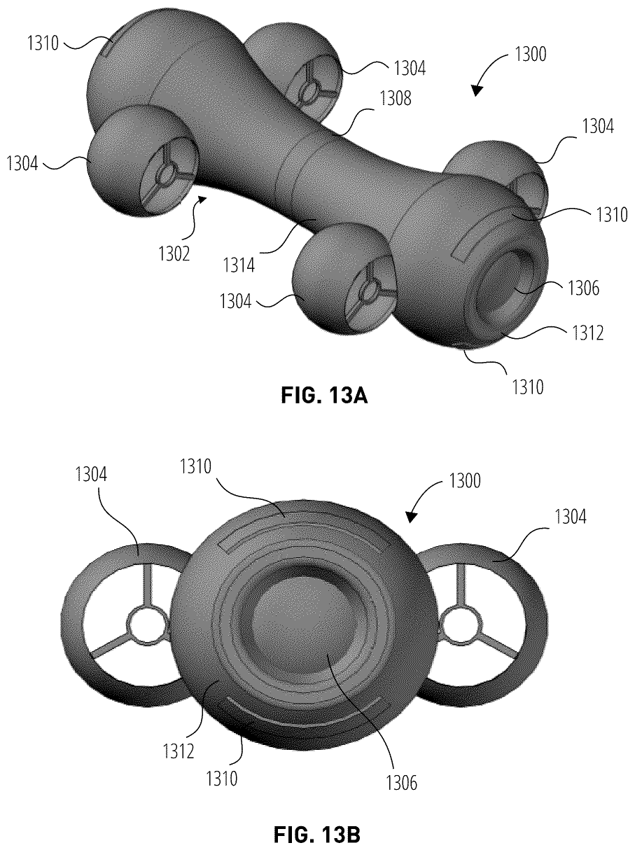

Referring to FIG. 13A and FIG. 13B, a quad-thruster AUR 1300 is provided. In this example, four thrusters 1304 are positioned symmetrically around quad-thrust quad-thruster main body 1302. The thrusters 1304 are configured for maneuverability and to hover or remain stationary against fluid flow. In this example, the quad-thruster AUR 1300 includes an optic sensor 1306. Optic sensor 1306 may include a high-resolution camera for capturing image information. The optic sensor 1306 is positioned on a front side of the quad-thruster AUR 1300 and slightly inset of the quad-thruster main body 1302. This provides damage protection during use when contacting unintentional objects. In this example, the optic sensor 1306 is circular and may include a protective door that opens and closes to further protect the optic features. Impact bumpers 1312 are positioned around optic sensor 1306 and integrated with quad-thruster main body 1302. The impact bumpers 1312 are also provided to protect quad-thruster AUR 1300's physical integrity and internal components. A pressure-resistant hull 1314 is provided and crafted from lightweight, yet durable materials, ensuring structural integrity under potential high pressures. The quad-thruster main body 1302 may further include internal flexible bladders that can be filled or emptied to tune buoyancy, ensuring positive positioning during inspections.

The quad-thruster main body 1302 includes a body core 1308 for housing the power source, navigation, and communication control through a controller. Similar to the quad-thruster AUR 100, the body core 1308 may include a ballast system 108 for buoyancy control actuation, power transfer magnet capture 110 for power transfer when recharging. In this example, two oppositely positioned lights 1310 are positioned next to the optic sensor 1306 and impact bumpers 1312, which may include red, green, blue (“RGB”) light structured sensors. Thrusters 1304 are generally linear thrusters; however, they can be modified to tilt to facilitate additional maneuverability.

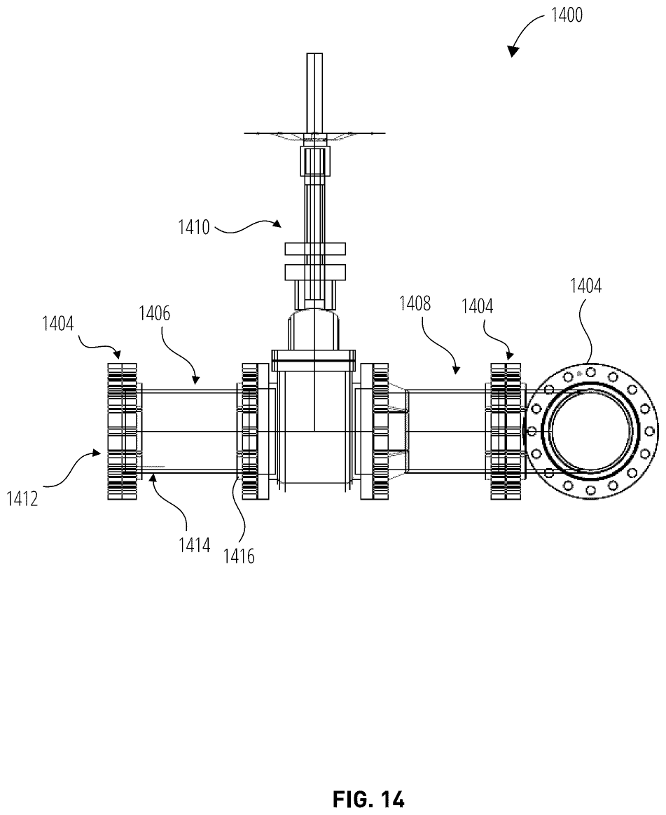

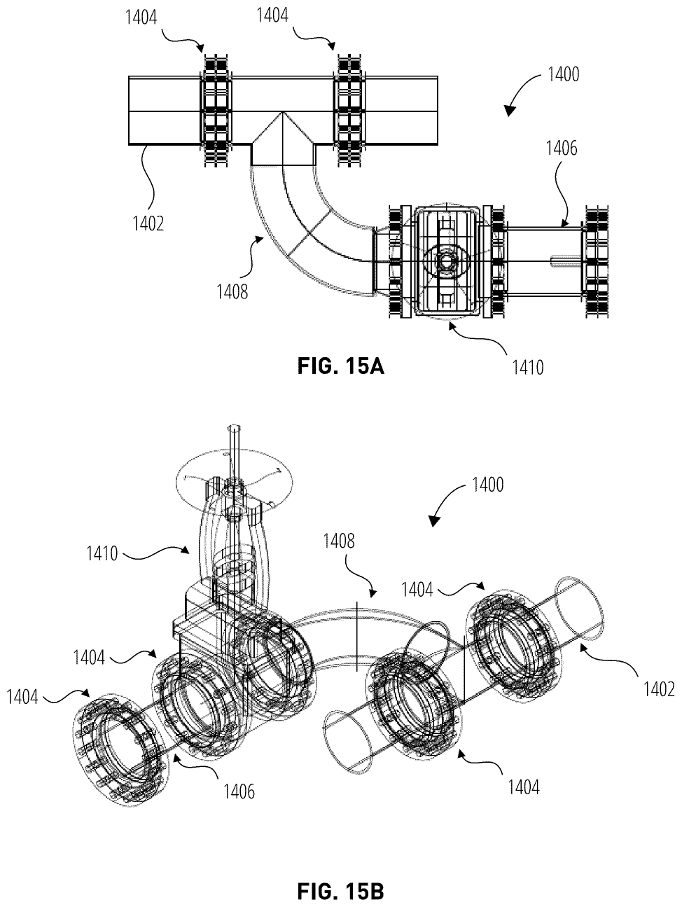

Referring to FIG. 14, FIG. 15A and FIG. 15B, the present disclosure provides for an alternative HDS system referred to as a pressure chamber HDS system 1400 shown schematically within a pipe system 1402. Pressure chamber HDS system 1400 is configured to facilitate deployment, retrieval, recharging, and data management of AURs within pipe system 1402 and includes a communication module. It is characterized by its multi-functional design that provides an effective interface between the AUR and the pipe system 1402 for which they are intended. In this example, the pressure chamber HDS system 1400 can be introduced into a pipe system 1402 and allow for the AUR to be removed as needed for access, maintenance, etc. After data is collected. In another example, pressure chamber HDS system 1400 includes a chlorination pressure chamber 1406 that is removable and accessible without interruption of an existing pipe system 1402.

Pressure chamber HDS system 1400 includes a chlorination pressure chamber 1406 having a stop or opening/exit door 1412. Opening/exit door 1412 allows for access to 1406 to retrieve or access the AUR. The system can further include an emergency pressure release mechanism in the chlorination pressure chamber 1406 to safeguard against unexpected pressure surges or system malfunctions.

In this example, the pressure chamber HDS system 1400 is connected to pipe system 1402 and includes a secondary chamber 1408 for initial entry of the AUR for data transmission, power charging, and/or holding until the system is ready to move the AUR into 1406. The pressure chamber HDS system 1400 can further be equipped with a fluid sampling and treatment module for testing and managing water quality before reintroducing fluid into the main pipeline. Chlorination pressure chamber 1406 can even further include an integrated flushing mechanism to ensure any residual contaminants are removed prior to AUR re-entry into the pipeline. The chlorination module can be coupled with an automated fluid balancing system that ensures the reintroduction of water from the pressure chamber to the pipeline meets regulatory standards for chemical composition and flow rate.

Several pipe connections 1404 are shown for connecting to 1402. In an example, pipe connection 1404 can be a flanged connection including a saddle joint and/or a tapping sleeve or other feasible appurtenance connections. chlorination pressure chamber 1406 includes a Li-Fi sensor 1414 (light fidelity sensor) to facilitate cross communication with the AUR to communicate location information and identity. A bleed valve 1416 is also provided that is configured to adjust the pressure within the chlorination pressure chamber 1406. The Li-Fi sensor 1414 is configured to transmit high-speed data between the pressure chamber HDS system 1400 and the AUR and optionally supports alternative communication methods such as acoustic signals or radio-frequency transmissions to adapt to pipeline conditions. In another example, the system further includes a multi-channel communication module that simultaneously supports Li-Fi, sound-based signals, and radio-frequency transmission for redundant and reliable data exchange between the HDS and the AUR. The system can include adaptive functionality to switch between Li-Fi and sound-based signals based on environmental conditions such as turbidity or obstructions in the fluid pipeline. The communication module can be equipped with high-speed Li-Fi transmitters embedded within the 1406 to facilitate uninterrupted communication with the AUR during operations.

Pressure chamber HDS system 1400 further includes a gate valve 1410 that allows the AUR to advance from the secondary chamber 1408 to the chlorination pressure chamber 1406. Secondary chamber 1408 can include magnetic inductance for energy and data transfer. Gate valve 1410 can be an automatic or a manual gate valve. An automated control system is configured to regulate the opening and closing of the gate valve in synchronization with the chlorination pressure chamber 1406 operations to maintain system integrity during AUR deployment and retrieval. In this example, a gate valve 1410 is provided, however, it is within the scope of the present disclosure that other suitable valves or valve constructions can be used such as, for example, butterfly valves, ball valve, etc. Gate valve 1410 is configured to isolate the pressure chamber during maintenance or AUR deployment to ensure minimal disruption to the pipeline. The gate valve 1410 can include a mechanism configured to be remotely operable via the HDS communication module to allow for precise, on-demand control during AUR deployment and retrieval.

Pressure chamber HDS system 1400 features a magnetic capture mechanism that aligns and secures the AUR upon re-entry into an HDS-pipe junction. This magnetic capture system also functions as an inductive charging platform, providing the power required to recharge the AUR's power source. Pressure chamber HDS system 1400 may also include a data transfer interface. The magnetic capture mechanism is equipped with data transfer capabilities. Upon entry, the AUR engages in a data upload transferring gathered inspection data for processing and subsequent relay to a GIS and/or cloud network. A real-time diagnostics module can be provided for monitoring pressure levels, fluid composition, and system integrity within the chlorination pressure chamber 1406 and a corresponding pipeline connection.

Pressure chamber HDS system 1400 can be designed to be installed within existing access points in the pipe system 1402, such as gate valves 1410. This allows for easy access by maintenance personnel and integration into the pipeline infrastructure. Water quality management can be integral to the design focused on maintaining the water quality within the pipe system 1402.

Pressure chamber HDS system 1400 can be provided as a modular system that allows for rapid adaptation to different pipeline diameters and profiles without significant structural modification. In an example, the docking station can include an integrated cleaning system configured to remove debris and contaminants from the AUR surface upon docking.

In another example, the docking station can further include a predictive analytics system configured to determine optimal deployment schedules for the AUR based on historical pipeline inspection data and real-time conditions. The communication and sensory array can include an encryption module to secure data transmitted between the docking station and external systems.

The HDS of the present disclosure can include an automated firmware update mechanism to enhance the functionality of docked AURs. Pressure chamber HDS system 1400 provides for a pressure chamber configured to facilitate safe entry and retrieval of the AUR into and from the connected fluid pipeline system. The pressure chamber is configured to maintain environmental equilibrium to prevent pressure surges or leaks in the pipeline.

The chlorination pressure chamber 1406 can further include a chlorination module to neutralize contaminants from the water before interacting with the AUR, ensuring safe operational conditions for AUR equipment.

Chlorination pressure chamber 1406 can be configured to automatically monitor and adjust the chemical composition of the water within the pressure chamber to maintain compatibility with AUR materials and sensors. It can also include a safety interlock system that prevents the gate valve 1410 from opening unless it is confirmed that a balanced pressure state with the connected pipeline system.

Pressure chamber HDS system 1400 should be constructed of materials resistant to chemical corrosion, ensuring long-term operational integrity in treated water environments. It may also include an environmental monitoring system integrated with the chlorination pressure chamber 1406 to detect and log conditions such as temperature, PH levels, and chemical concentrations during AUR deployment.

The present disclosure provides for failover protocols to ensure continued operation of the system in the event of partial component failure. The system can be configured to coordinate simultaneous deployments of multiple AURs to inspect separate pipeline segments concurrently. In an example, the system integrates augmented reality technology to allow operators to visualize pipeline inspection data in near real-time. In yet another example, a centralized data management system is deployed that uses synthetic datasets to train machine learning algorithms for enhanced inspection and predictive maintenance. In yet an even further example, all components, including AURs, docking stations, AISDS, and locator rings, are designed to be interoperable with third-party infrastructure management systems.

The present disclosure provides for a method of using the system or systems as described above that includes the steps of deploying a plurality of AURs from a single docking station to perform synchronized inspections of multiple pipeline systems. The method can further include analyzing inspection data in real-time using AI-driven analytics to generate predictive maintenance schedules for pipeline infrastructure. The docking station can be configured to dynamically adjust AUR deployment based on real-time pipeline pressure, flow rates, and detected anomalies. The method can further utilize locator rings to pinpoint the exact location of pipeline breaches or AUR malfunctions during disaster recovery operations. Energy harvested from pipeline fluid flow can power some or all system components, ensuring sustainability during extended operations.

The Figures represent only a selection of possible thruster and propulsion variants for the autonomous robotics. There remains a potential for numerous other designs, tailored for specific operational needs or environmental conditions that are within the scope of this disclosure. It should be noted that the steps described in the method of use can be conducted in many different orders according to user preference. The use of “step of” should not be interpreted as “step for,” in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination, or addition of certain steps, including or excluding certain maintenance steps, etc., may be sufficient.

What is claimed is:

1. An autonomous underwater robotic (AUR) vehicle for use in pipe inspection, the AUR vehicle comprising:
(a) a main body configured for housing a controller coupled to one or more sensors;
(b) a propulsion system having one or more thrusters configured for propelling the AUR vehicle through a target system;
(c) a rechargeable power source provided in the main body and coupled to the controller;
(d) a data storage module coupled to the one or more sensors configured for storing and transmitting any acquired data from the one or more sensors;
(e) at least one camera configured for capturing images; and
(f) a navigation system configured to direct the AUR vehicle and finding a docking station for data transfer and power recharge.

2. The AUR vehicle of claim 1, wherein the propulsion system includes between two to eight thrustors positioned around the main body.

3. The AUR vehicle of claim 1, wherein the one or more sensors include a pressure sensor, a temperature sensor, an ultrasonic sensor, a conductivity probe, a sonar sensor, or a combination thereof.

4. The AUR vehicle of claim 1, wherein the one or more sensors are configured to be interchangeable for detecting a pipeline characteristic selected from the group consisting of water quality, structural integrity, and corrosion levels.

5. The AUR vehicle of claim 1, wherein the navigation system is configured to be controllable remotely or in communication with a docking station.

6. The AUR vehicle of claim 1, further comprising a ballast system for buoyancy control in communication with the controller.

7. The AUR vehicle of claim 1, wherein the main body is formed of a protective material sufficient to withstand high pressure and contaminated environments.

8. The AUR vehicle of claim 1, wherein the main body includes an exterior coating including an anti-biofouling material configured to prevent contamination or clogging during deployment.

9. The AUR vehicle of claim 1, wherein the thrustors are fixed or pivoting thrustors.

10. The AUR vehicle of claim 1, wherein the propulsion system includes a primary rear thruster and secondary vectored thrusters configured for maneuverability and vertical control.

11. The AUR vehicle of claim 1, wherein the main body includes an impact bumper, an optic sensor, and one or more light sensors.

12. The AUR vehicle of claim 11, wherein the optic sensor is a high-resolution camera. and the one or more light sensor is an RGB light structured sensor.

13. The AUR vehicle of claim 1, wherein the main body includes:
(a) a body core configured for housing the power source,
(b) a ballast system,
(c) a hull gap configured for buoyancy control,
(d) three or more sensors, and
(e) magnet capture for data and power transfer.

14. The AUR vehicle of claim 1, further comprising a machine learning module coupled to the controller and configured to optimize inspection routes based on real-time data and historical performance metrics related to the target system.

15. A fluid pipe inspection and assessment system comprising an AUR vehicle of claim 1 and a docking station configured for recharging power and communicating with the AUR vehicle.

16. A Home Docking Station (HDS) configured to attach directly to a fluid pipeline system and provide a launch and retrieval point for an autonomous underwater robotic (AUR) vehicle, comprising:
(a) a chlorination pressure chamber configured decontaminating an AUR vehicle and adjusting the pressure within the chamber configured to allow access to retrieve or deploy the AUR vehicle;
(b) a secondary chamber having an internal magnetic capture mechanism configured for transmitting data, power charging, and holding the AUR before entering the chlorination pressure chamber; and
(c) a communication and sensory array configured to detect proximity of the AUR vehicle and a communication module for remote communication with operators;
wherein the magnetic capture mechanism is equipped with a data transfer module configured for data upload and transferring gathered inspection data for processing and subsequent relay to a GIS and/or cloud network when an AUR vehicle is docked.

17. The HDS of claim 16, wherein the secondary chamber includes a magnetic inductive charging platform configured for providing power required to recharge the AUR vehicle.

18. The HDS of claim 16, further comprising a magnetic retrieval system for capturing the AUR as it returns from inspections within the fluid pipeline system.

19. The HDS of claim 16, wherein the internal magnetic capture mechanism is equipped with recharging facilities configured to replenish the power of the AUR vehicle post-inspection and prior to subsequent deployment.

20. The HDS of claim 16, wherein the external housing is compatible with various fluid pipeline systems, including water mains, oil pipelines, and other fluid transport systems.
